(19) United States
(12) Patent Application Publication
(10) Pub. No.: US 2020/0256346 A1
(43) Pub. Date: Aug. 13, 2020

(54) METHOD FOR CONTROLLING ROTATIONAL SPEED OF MOTOR OF FAN

(71) Applicant: Aether Services, Taiwan, Ltd., Hsinchu City (TW)

(72) Inventors: Jui-Pin Wu, HSINCHU CITY (TW); Chun-Yuan Lee, HSINCHU CITY (TW); Chen-Chia Tsai, HSINCHU CITY (TW); Ying-Peng Wu, HSINCHU CITY (TW)

(21) Appl. No.: 16/861,376

(22) Filed: Apr. 29, 2020

Related U.S. Application Data
(63) Continuation-in-part of application No. 15/832,868, filed on Dec. 6, 2017.
(60) Provisional application No. 62/432,774, filed on Dec. 12, 2016.

(51) Int. Cl. F04D 27/00; F04D 29/70

(52) U.S. Cl. CPC F04D 27/004; F04D 29/703; F05D 2260/821; F05D 2260/607; F05D 2270/02

(57) ABSTRACT

A method for controlling a rotational speed of a motor of a fan is provided in the present application, applicable to an air cleaner and including: calculating a suitable rotational speed range according to a space size of a use environment and a filter gauze type of the air cleaner; calculating a suitable rotational speed according to air quality sensed by a sensor or air quality information; subsequently, adjusting a rotational speed offset according to a relatively high or a relatively low rotational speed preferred by a user; checking whether a range at present is a timing enhancement range; determining that the rotational speed is not higher than a noise upper limit rotational speed; and setting a rotational speed of a motor of a fan.

### CROSS-REFERENCE TO RELATED APPLICATION

This CIP application claims the benefit of U.S. patent application Ser. No. 15/832,868, filed on Dec. 6, 2017, which is hereby incorporated by reference for all purposes as if fully set forth herein.

### BACKGROUND

### Technical Field

The present application relates to a method for controlling a rotational speed of a motor of a fan, and in particular, to a method for controlling a rotational speed of a motor of a fan applicable to an air cleaner. The rotational speed of the motor is adjusted according to air quality obtained by sensing a surrounding environment by a sensor disposed on the air cleaner or air quality information.

### Related Art

Generally, when air quality is poor, a cleaner needs to accelerate its operation to quickly clean the air; when air quality is good, the cleaner can operate at a lower speed or stop operating to save energy. Because the air quality changes with time or occurrence of some events, for example, opening a window, smoking, cooking, or burning incense, the rotational speed of the cleaner needs to be adjusted accordingly.

Usually, a user can manually adjust the wind speed, but the user probably cannot always pay attention to the air quality and quickly adjust the rotational speed. On the other hand, the user probably cannot perceive that the air quality has deteriorated and how poor the air quality has become, because particles in air are invisible to naked eyes and some organic gases are colorless and odorless and cannot be detected by humans. Therefore, an effective method is to build a sensor in the cleaner. When the sensor detects that the air quality changes, the rotational speed of the cleaner is appropriately adjusted in response to the change in the air quality.

At present, most cleaners having a built-in sensor on the market support such an automatic operation mode, which is referred to as a conventional automatic operation mode herein. In the conventional automatic operation mode, generally, there is a fixed correspondence for adjusting the rotational speed of the motor of the fan of the cleaner according to air quality detected by the sensor of the cleaner. For example, assuming that the air quality is divided into four levels (or more or less levels), the motor operates at a fixed rotational speed of, for example, 400 rpm when the air quality is at the first level (best quality), at a fixed rotational speed of 700 rpm when the air quality is at the second level, at a fixed rotational speed of 1000 rpm when the air quality is at the third level, and at a fixed rotational speed of 1300 rpm when the air quality is at the fourth level (worst quality). Although this method is more convenient that the manner in which a user manually adjusts the rotational speed of the motor according to the air quality, the correspondence between the air quality and the rotational speed is not the most appropriate most of the time or cannot truly meet user requirements. Specific cases are provided below.

1. When the cleaner is placed in spaces of different sizes and under a same air condition, if same air quality is expected to be maintained, the cleaner should have different rotational speeds because different quantities of air need to be cleaned. However, in the conventional automatic operation mode, a same rotational speed is used. 2. Even if the cleaner is placed in a same space, the cleaner has different air cleaning capabilities (CADR: Clean Air Delivery Rate) when using different types of cleaner filter gauzes. To achieve a same cleaning rate, when different types of cleaner filter gauzes are used in the case of same air quality, the cleaner should have different rotational speeds. However, in the conventional automatic operation mode, a same rotational speed is used. 3. Even if the cleaner is placed in a same space and uses a same filter gauze, because some people may feed a pet at home, or have a child having allergies at home, or are quite sensitive to dirty air, and prefers the automatic operation mode but expect a higher rotational speed, the conventional automatic operation mode cannot meet such a personal requirement. 4. In addition, in some special places, for example, a hospital, a studio, and a chemical laboratory, in addition to the conventional automatic operation mode, the user expects that the cleaner is capable of accelerating operation for a period of time at intervals regardless of the air quality and then returning to the automatic mode. The conventional automatic operation mode cannot meet such a special requirement. 5. Some users buy more than one cleaner and place them at different positions in a large space, for example, one in a kitchen and one in a living room. When cooking is performed in the kitchen and the cleaner in the living room automatically operates, the cleaner not only refers to its own sensor, but may also refer to a sensor of another cleaner specified by the user, for example, a sensor of the cleaner in the kitchen. The cleaners cooperate to quickly filter air until the air in the entire living room and kitchen are clean. The conventional automatic operation mode cannot meet the requirement of such cooperative operation. 6. If a window of a house is often open, when outdoor air quality deteriorates, the cleaner also needs to increase the rotational speed accordingly. In the conventional automatic operation mode, the rotational speed cannot be automatically adjusted according to the outdoor air quality. 7. Some users have the elderly and children who like a relatively quiet environment at home. Therefore, such users expect that when the cleaner automatically operates, even if air quality is very poor, the cleaner does not operate too loudly. The conventional automatic operation mode cannot meet such a personal requirement.

Therefore, for determining of a rotational speed in the automatic operation mode, the rotational speed needs to be adjusted not only according to air quality sensed by a sensor of the cleaner, but more factors such as a room size and a filter gauze type also need to be referred to. In addition, special personal requirements such as accelerated operation, an intermittent acceleration, and a noise upper limit need to be met. Moreover, outside information is referred to by taking advantage of networking, to fully use benefits of the automatic operation mode. Only in this case can the automatic operation mode be the most intelligent one and best meet personal requirements.

### SUMMARY

An objective of the present application is mainly to provide a method for controlling a rotational speed of a motor of a fan of an air cleaner. A space environment is sensed by a sensor, to control a rotational speed of a motor of a fan of an air cleaner based on a personal preference and requirement. In this way, an automatic operation mode of the air cleaner is smarter and more intelligent.

The method for controlling a rotational speed of a motor of a fan is provided in the present application. The method is applicable to an air cleaner and comprises: calculating a suitable rotational speed range according to a space size of a use environment and a filter gauze type of the air cleaner; calculating a suitable rotational speed according to air quality sensed by a sensor or air quality information, where the air quality information may be current air quality information on the network; adjusting a rotational speed offset according to a relatively high or a relatively low rotational speed preferred by a user; checking whether a range at present is a timing enhancement range; determining that the rotational speed is not higher than a noise upper limit rotational speed; and setting a rotational speed of a motor of a fan.

### BRIEF DESCRIPTION OF THE DRAWINGS

FIG. 1 is a flowchart of a method for controlling a rotational speed of a motor of a fan.

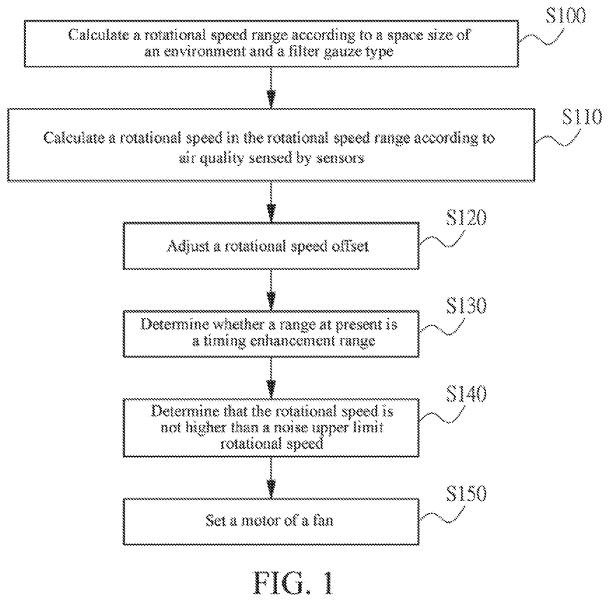

### DETAILED DESCRIPTION

To further understand the objective, structural features, and functions of the present application, descriptions are provided in detail with reference to related embodiments and figures as follows:

In the conventional automatic operation mode, there is a fixed correspondence between air quality and the rotational speed of the motor of the fan. For example, there are four levels of air quality: good, ordinary, not good, and very poor, and corresponding fixed rotational speeds of the motor of the fan are: 400 rpm, 700 rpm, 1000 rpm, and 1300 rpm. The rotational speed is always 400 rpm, 700 rpm, 1000 rpm, or 1300 rpm regardless of the size of a space in which a cleaner is placed. As can be learned, assuming that the air quality is not good and the rotational speed is 1000 rpm, a relatively small space quickly becomes clean again, but in a relatively large space, a user needs to tolerate unclean air for a relatively long time. Is there any way for the relatively large space to quickly become clean again as the relatively small space?

In fact, the relatively large space can quickly become clean again as the relatively small space as long as the cleaner considers a space size when determining a rotational speed as the air quality is not good. The rotational speed is relatively low when the space is small, and the rotational speed is relatively high when the space is large. In this way, spaces of different sizes may become clean again within a same period of time.

Second, a cleaning capability of the cleaner is related to a filter gauze type. Different filter gauzes usually correspond to different CADR values of the same cleaner. For example, using a PM2.5 filtering capability as an example, a pure HEPA filter gauze usually has a better filtering capability than that of a compound filter gauze of a same size. Filter gauzes made of filtering materials of different filtering levels have different filtering capabilities. Certainly, a filter gauze is selected based on different considerations. Once the filter gauze is selected, when the rotational speed of the motor of the fan is determined, a filtering capability of the filter gauze needs to be considered, so that a same cleaning speed can be reached.

Therefore, after the air quality is determined, the cleaner needs to calculate a suitable rotational speed of the motor according to the space size and the filter gauze type.

How to determine the air quality? Is a sensor of the cleaner the only reference? Theoretically, air quality at each position in a space will finally be the same. However, in fact, how fast will the same air quality be achieved is related to the space size and efficiency of air circulation. Therefore, if more sensors are placed in the space, the air quality in the space can be detected more accurately than the case where only one sensor is used.

Using this concept as a starting point, the cleaner needs to refer to other sensors in the same space when determining the air quality.

Values of other sensors may be obtained by various means such as a network or other extended connection, as long as the values can be obtained.

After the values are obtained, final air quality may be determined by using different policies, for example, a worst air quality policy (the worst one of all values) or a weighted averaging policy (weighted average of all values).

In short, after the air quality is determined, the suitable rotational speed of the motor may be calculated according to the space size and the filter gauze type.

In addition to values of other nearby sensors may be used as references of the air quality, the cleaner may obtain outdoor air quality by using the network as a reference too. If a user also expects to refer to the outdoor air quality to determine a rotational speed of the motor, the outdoor air quality may also be referred to when the final air quality is determined.

An automatic operation mode has various advantages. If the user prefers a quicker cleaning effect, or a quieter and more energy-saving effect, can both effects be achieved? Yes, both of the effects can be achieved as long as the cleaner additionally considers a user's personal preference and accelerates or decelerates the rotational speed when determining a rotational speed. In this way, the rotational speed not only can be automatically determined but also satisfies the personal preference.

Another requirement is that, on one hand, the cleaner is expected to be capable of operating automatically; on the other hand, the cleaner is expected to be capable of accelerating operation for a period of time at intervals regardless of the air quality. Can the requirement be met? Yes, the requirement can be met as long as the cleaner checks whether an “enhancement range” arrives before determining the final rotational speed. If the “enhancement range” arrives and the rotational speed is not enough, the cleaner increases the rotational speed and the requirement is met.

Finally, if the user does not expect too much noise of the cleaner regardless of the air quality, can the rotational speed of the cleaner be kept not exceeding a “noise upper limit” that can be tolerated by the user? Yes, the rotational speed can be kept not exceeding the noise upper limit as long as it is checked, when the final rotational speed is determined, whether the rotational speed exceeds a noise upper limit rotational speed set by the user. If the rotational speed exceeds the noise upper limit rotational speed, the rotational speed is limited.

In the conventional automatic operation mode, the rotational speed is determined only according to the air quality sensed by the sensor without considering that the rotational speed needs to be adjusted according to the space size and the filter gauze type. In addition, unique personal requirements such as a personal preference for the rotational speed (preference for quicker filtering or being quieter), a requirement for timing enhancement, and too much noise are not considered. Information of external sensors are not referred to by taking advantage of networking to enable the cleaners to operate collaboratively to more quickly react to a change in the air quality and more quickly clean a larger place. The method for automatically controlling a rotational speed of a motor of a fan provided by the present application meets all these requirements.

The method for controlling a rotational speed of a motor of a fan of an air cleaner of the present application includes: first, step S100: Calculate a suitable rotational speed range according to a space size and a filter gauze type of the use environment of the cleaner. That is, according to a corresponding filter gauze type, the cleaner is capable of delivering a quantity of clean air within a unit of time, referred to as a clean air delivery rate (CADR), and a rotational speed fan-CADR of the fan of the cleaner under such a CADR condition. Information sampling includes:

1. According to space size information A (square meter) provided by a user, assuming that a space height is H meters, a ratio of sundries to space (i.e., the ratio of sundries to space is defined as the proportion of objects e.g., pillars, furniture, etc. in the space that compete with air relative to the overall space) is p (0<p<1), air in the space is filtered for a maximum of T-max times per hour, and air in the space is filtered for a minimum of T-min times per hour, a necessary fan rotational speed (fan-T-max) is recommended to be:

fan-T-max=fan-CADR×A×H×(1−p)×T-max/CADR (formula 1)

2. Another necessary fan rotational speed (fan-T-min) is recommended to be:

fan-T-min=fan-CADR×A×H×(1−p)×T-min/CADR (formula 2)

It is recommended that the air cleaner should clean the designate space at least T-min times per hour and at most T-max times per hour depending on the air quality.

Step S110: Calculate a suitable rotational speed in the rotational speed range according to air quality sensed by sensors (sensors attached to the air cleaner, sensors on other external devices and/or outdoor sensors). A main calculating sampling manner is as follows:

Because values of the sensor has a lot of disturbance and errors, it is not necessary to adjust the rotational speed of the fan each time when the value changes. A relatively appropriate method is to divide the values of the sensor into several ranges N, for example, six ranges. Each range corresponds to one air quality level.

The cleaner may have one or more sensors, for example, one PM2.5 sensor, one PM10 sensor, and one TVOC sensor. Values of other external sensors may be referred to by means of user setting. An outdoor air quality index may be referred to. Before the rotational speed of the fan is determined, comprehensive air quality needs to be first determined.

Each value of the sensor corresponds to one air quality range. Certainly, different types of sensors have different correspondence manners. In the present application, an air quality index (AQI) is used as an example. As shown in Table 1 (a reference data source: https://en.wikipedia.org/wiki/Air_quality_index), PM2.5 and PM10 can correspond to the air quality ranges as follows:

TABLE 1
part I

| O₃ (ppb) | | O₃ (ppb) | PM_{2.5} (μg/m³) | | PM₁₀ (μg/m³) | | |
|---|---|---|---|---|---|---|---|
| C_{low}-C_{high} | | C_{low}-C_{high} | C_{low}-C_{high} | | C_{low}-C_{high} | | AQI |
| (avg) | | (avg) | (avg) | | (avg) | | Category |
| 0-54 | (8-hr) | | 0.0-12.0 | (24-hr) | 0-54 | (24-hr) | Good |
| 55-70 | (8-hr) | | 12.1-35.4 | (24-hr) | 55-154 | (24-hr) | Moderate |
| 71-85 | (8-hr) | 125-164 (1-hr) | 35.5-55.4 | (24-hr) | 155-254 | (24-hr) | Unhealthy for |
| | | | | | | | Sensitive Groups |
| 86-105 | (8-hr) | 165-204 (1-hr) | 55.5-150.4 | (24-hr) | 255-354 | (24-hr) | Unhealthy |
| 106-200 | (8-hr) | 205-404 (1-hr) | 150.5-250.4 | (24-hr) | 355-424 | (24-hr) | Very Unhealthy |
| | | 405-504 (1-hr) | 250.5-350.4 | (24-hr) | 425-504 | (24-hr) | Hazardous |
| | | 505-604 (1-hr) | 350.5-500.4 | (24-hr) | 505-604 | (24-hr) | Hazardous |

part II

| CO (ppm) | | SO₂ (ppb) | | NO₂ (ppb) | | | |
|---|---|---|---|---|---|---|---|
| C_{low}-C_{high} | | C_{low}-C_{high} | | C_{low}-C_{high} | | AQI | AQI |
| (avg) | | (avg) | | (avg) | | I_{low}-I_{high} | Category |
| 0.0-4.4 | (8-hr) | 0-35 | (1-hr) | 0-53 | (1-hr) | 0-50 | Good |
| 4.5-9.4 | (8-hr) | 36-75 | (1-hr) | 54-100 | (1-hr) | 51-100 | Moderate |
| 9.5-12.4 | (8-hr) | 76-185 | (1-hr) | 101-360 | (1-hr) | 101-150 | Unhealthy for |
| | | | | | | | Sensitive Groups |
| 12.5-15.4 | (8-hr) | 186-304 | (1-hr) | 361-649 | (1-hr) | 151-200 | Unhealthy |
| 15.5-30.4 | (8-hr) | 305-604 | (24-hr) | 650-1249 | (1-hr) | 201-300 | Very Unhealthy |
| 30.5-40.4 | (8-hr) | 605-804 | (24-hr) | 1250-1649 | (1-hr) | 301-400 | Hazardous |
| 40.5-50.4 | (8-hr) | 805-1004 | (24-hr) | 1650-2049 | (1-hr) | 401-500 | Hazardous |

For other sensors, a similar correspondence manner may be used, as long as quantities of corresponding ranges are the same. Different policies may be used to determine the comprehensive air quality. The worst air quality is used as reference, or weighted averaging is used: Different weighted values are allocated to different sensors. In short, after the comprehensive air quality is determined, assuming that the air quality falls in an n^{th} range (1<=n<=N), the rotational speed of the fan (fan-n) is:

fan-n=fan-T-min+(fan-T-max−fan-T-min)×(n−1)/(N−1) (formula 3).

Subsequently, step S120: Adjust a rotational speed offset according to a relatively high or a relatively low rotational speed preferred by a user. The user may accelerate or decelerate the rotational speed (fan-offset) because a family member has allergies or a pet is fed at home, or because of a personal preference of a quicker cleaning effect, a personal preference of a more energy-saving and quieter effect, or another personal preference. In this case, the rotational speed becomes: fan-n+fan-offset.

Subsequently, step S130: Determine whether a range at present is a timing enhancement range. In some special places, for example, a clinic or a studio, a user may force a cleaner to operate at a relatively high rotational speed (fan-boost) for m minutes at an interval of M minutes. If the range falls in the “m” range, the rotational speed is:

fan-n′=max of((fan-n+fan-offset),fan-boost) (formula 4-1),

else, the range is not in the “m” range, the rotational speed is:

fan-n′=max of((fan-n+fan-offset),fan-MIN) (formula 4-2),

fan-MIN is a lower limit of the rotational speed of the cleaner.

Subsequently, step S140: Determine that the rotational speed is not higher than a noise upper limit rotational speed (fan-noise), and set a final rotational speed (fan-final) of a motor of a fan. That is, finally, before the rotational speed of the motor is set, it needs to be determined that the rotational speed of the fan is not higher than the noise upper limit rotational speed (fan-noise). Therefore, a final rotational speed is fan-final=min of (fan-n′, fan-noise) (formula 5).

Finally, step S150: Set a motor of a fan according to fan-final. It should be noted that, fan-n′ may be greater than an upper limit of the rotational speed of the motor of the fan (fan-MAX) (the hardware limit of the cleaner), but fan-noise definitely cannot exceed the upper limit of the rotational speed of the motor; therefore, fan-final cannot exceed the upper limit of the rotational speed of the motor.

In addition to the smart function and personal preferences mentioned above, the following can also be combined: 1. Scheduling: The cleaner is powered on or off at a specified time according to a personal requirement. 2. Sleeping: At a scheduled time, the cleaner enters a sleep mode. In the sleep mode, the following parameters can be set: LED luminance, a personally preferred rotational speed offset, a noise upper limit rotational speed, and the like.

As described above, implementations of the present application are as follows:

It is assumed that there are three types of filter gauzes of the cleaner, values of the CADR that correspond to the filter gauzes and that are measured at a rotational speed of fan-CADR=1300 rpm are respectively 150 CMH, 200 CMH, and 250 CMH (m³/h). An upper limit of the rotational speed of the cleaner is fan-MAX=1300 rpm (hardware limit), and a lower limit is fan-MIN=200 rpm (hardware limit). The air quality is divided into 6 levels. At the same time, it is assumed that the height of a room is H=2.4 m, the ratio of sundries to space (i.e., the ratio of sundries to space is defined as the proportion of objects in the space that compete with air relative to the overall space) is p=0.3, air in the space is filtered for a maximum of T-max=5 times per hour, and the air in the space is filtered for a minimum of T-min=1 time per hour.

Example 1: The size of the room is A=20 square meters, the filter gauze is a filter gauze 2, and the CADR=200 CMH.

1. According to formula 1: fan-T-max=fan-CADR×A×H×(1−p)×T-max/CADR=1300×20×2.4×(1−0.3)×5/200=1092.

2. According to formula 2: fan-T-min=fan-CADR×A×H×(1−p)×T-min/CADR=1300×20×2.4×(1−0.3)×1/200=218.4.

3. In this case, a PM2.5 value of the sensor of the cleaner is 20 μg/m³ and corresponds to the air quality in the second range according to Table 1. In addition, the cleaner also refers to an external PM2.5 sensor (such as an air quality detector). A value of the external PM2.5 sensor is 40 μg/m³ and the air quality is in the third range according to Table 1. The cleaner also refers to a local outdoor PM2.5 value and the value is 5 μg/m³. The air quality is in the first range according to Table 1. If the air quality is evaluated by using the worst air quality policy, the comprehensive air quality falls in the third range. According to formula 3: fan-n=fan-T-min+(fan-T-max−fan-T-min)×(n−1)/(N−1), fan-3=218.4+(1092−218.4)×(3−1)/(6−1)=567.84 (rpm).

4. Assuming that the user has a child and also feeds three cats at home, and the user expects the cleaner to be capable of cleaning indoor air more quickly, the user accelerates the rotational speed fan-offset=100 rpm. In this case, the rotational speed becomes: fan-3+fan-offset=667.84 (rpm).

5. In addition, the user personally has a relatively high requirement on air quality, and hopes that the cleaner can accelerate operation for 3 minutes at an interval of 10 minutes, and fan-boost set by the user is fan-boost=900 rpm. Therefore, if the cleaner has not entered an acceleration range, according to formula 4-2, the rotational speed maintains 667.84 rpm; if the cleaner at present is in the acceleration range, as shown in formula 4-1, the rotational speed is increased to 900 rpm. Assuming that the cleaner has not entered the acceleration range, the rotational speed is 667.84 rpm.

6. A value of the noise upper limit set by the user personally is fan-noise=1100 rpm. Because the rotational speed at present does not exceed fan-noise, as shown in formula 5, the rotational speed is 667.84 rpm.

7. Finally, the motor of the fan is set to the rotational speed.

An objective of the present application is mainly to provide a method for controlling a rotational speed of a motor of a fan of an air cleaner. A space environment is sensed by a sensor, to control the rotational speed of the fan of the motor of the air cleaner according to air quality and air quality information and based on a personal preference and requirement, where the air quality information is current air quality information on the network. In this way, an automatic operation mode of the air cleaner is smarter and more intelligent.

In conclusion, the foregoing descriptions are only intended to record the implementations or embodiments of technical means used to resolve problems in the present creation, but are not intended to limit the implementing scope of the present creation. That is, any equivalent changes and modifications consistent with the meaning within the application scope of the present creation or made according to the scope of the present creation shall fall within the scope of the present creation.

What is claimed is:

1. A method for controlling a rotational speed of a motor of a fan, applicable to an air cleaner and comprising the following steps:
calculating a rotational speed range according to a space size of an environment and a filter gauze type;
calculating a rotational speed in the rotational speed range according to air quality sensed by sensors;
adjusting the rotational speed according to a rotational speed offset (fan-offset);
determining whether a range is a timing enhancement range to enhance the rotational speed; and
determining that the rotational speed is not higher than a noise upper limit rotational speed (fan-noise), and setting a final rotational speed (fan-final);
wherein the rotational speed range comprises a highest fan rotational speed (fan-MAX) and a lowest fan rotational speed (fan-MIN), an area of the space is A square meters, a height of the space is H meters, a ratio of sundries to space (i.e., the sundries rate in the space is defined as the proportion of objects in the space that compete with air relative to the overall space) is p, air in the space is filtered by a maximum of T-max times per hour, the air in the space is filtered for a minimum of T-min times per hour, a quantity of air that can be cleaned by the filter gauze within each unit time is a clean air delivery rate (CADR), a fan rotational speed under the CADR condition is fan-CADR, and a necessary fan rotational speed (fan-T-max) is:
fan-T-max=fan-CADR×A×H×(1−p)×T-max/CADR, and
another necessary fan rotational speed (fan-T-min) is:
fan-T-min=fan-CADR×A×H×(1−p)×T-min/CADR.

2. The method for controlling a rotational speed of a motor of a fan according to claim 1, wherein values sensed by the sensor is divided into N ranges, and when the air quality falls in an n^{th} range in the N ranges, a rotational speed (fan-n) is:
fan-n=fan-T-min+(fan-T-max−fan-T-min)×(n−1)/(N−1).

3. The method for controlling a rotational speed of a motor of a fan according to claim 2, wherein a cleaner operates at a relatively high rotational speed (fan-boost) for m minutes when the enhancement range is at an interval of M minutes, and a rotational speed (fan-n′) is:
fan-n′=max of((fan-n+fan-offset),fan-boost).

4. The method for controlling a rotational speed of a motor of a fan according to claim 3, wherein the noise generated by the rotational speed is determined not to be higher than the noise upper limit rotational speed (fan-noise), and the final rotational speed (fan-final) is:
fan-final=min of(fan-n′,fan-noise).
